(19) United States
(12) Patent Application Publication
(10) Pub. No.: US 2007/0278783 A1
(43) Pub. Date: Dec. 6, 2007

(54) OVERSIZE PAGE FOLDING BOOK

(76) Inventor: Elizabeth Carpenter, New York, NY (US)

Correspondence Address: HUGHES HUBBARD & REED LLP, ONE BATTERY PARK PLAZA, NEW YORK, NY, 10004, US

(21) Appl. No.: 11/744,914

(22) Filed: May 7, 2007

Related U.S. Application Data
(60) Provisional application No. 60/810,563, filed on Jun. 1, 2006.

(51) Int. Cl. B42D 1/00

(52) U.S. Cl. 281/15.1

(57) ABSTRACT

Oversized pages are printed and bound on one edge instead of at the center. The printed cover is also bound to the pages at the same edge. The pages are folded in half as a group. The cover has been engineered to have enough space to go around the pages completely including two scored folds which imitate a book spine.

### CROSS-REFERENCE TO RELATED APPLICATION

This application claims the benefit of the filing date of the U.S. Provisional Application 60/810,563, filed on Jun. 1, 2006, entitled “Oversize Page Folding Book.”

### BACKGROUND OF THE INVENTION

1. Field of the Invention

This invention relates to book publishing, in particular, the production of oversize page books.

2. Description of Prior Art

The maximum size of a standard size book is approximately twelve inches high by ten inches wide. Books with larger dimensions are difficult to shelve, handle and ship.

Traditional bookbinding assembles flat sheets of paper in signatures, a set of printed sheets, which are then folded in half. For instance a signature of six sheets printed on both sides becomes twenty-four pages when folded. The signatures are then grouped together, aligned at the fold side. The grouped signatures are then bound together along the fold side by any of a variety of methods including, but not limited to, sewing, gluing, stapling and taping. As an example, four signatures of six sheets, printed both sides, will result in a book of ninety-six pages when traditionally bound.

When a traditionally bound book is opened, the center between two adjoining pages is called the gutter. When artwork to be printed is larger than the maximum page size of a standard book, it is traditionally printed on two facing pages. This generally results in a misalignment of the artwork at the gutter.

In the past, publishers have tried to solve the gutter misalignment problem by printing artwork on a single sheet of oversized paper. These oversized pages of artwork have then been bound together at the top end like a pad, or at the side, resulting in an oversized book. These oversized books are difficult to handle, shelve and ship.

In the past, publishers have tried to solve the oversized book problem by rolling the book into a tube. However, books in a tube are still difficult to handle and shelve. In addition, they are difficult to unroll, because paper stored tightly rolled in a tube develops a memory curl that is difficult to permanently flatten out again.

### BRIEF SUMMARY OF THE INVENTION

The present invention discloses a new way to bind oversize pages into standard size books. This allows large size artwork printed on a continuous or single sheet of paper to be bound together in a standard size book with out being mismatched at the book's gutter.

Oversized pages are printed and bound on one edge instead of at the center. The printed cover is also bound to the inside pages at the same edge. The inside pages are folded in half as a group. The cover has been engineered to have enough space to go around the inside pages completely including two scored folds which imitate a book spine.

The present invention is superior because it:
allows for artwork to be printed on an oversized sheet of paper,
does not have a gutter,
opens cleanly to flat pages without memory curl,
can be shelved in a standard sized bookcase,
appears as a traditional book with a readable spine when closed,
is easy to transport and ship, and
is less awkward to use and handle.

### BRIEF DESCRIPTION OF THE DRAWINGS

The invention can be better understood with reference to the following drawings. The components in the drawings are not necessarily to scale, emphasis instead being placed on clearly illustrating the principles of the present invention. In the drawings, like reference numerals designate corresponding parts throughout the several views.

FIG. 1 is the front cover view with the book closed.

FIG. 2 is the spine cover view of the book closed.

FIG. 3 is a perspective view from above the book when closed.

FIG. 4 is the back cover view with the book closed.

FIG. 5 is a view of the inside of the book when opened horizontally.

FIG. 6 is a view of the front, spine and back cover of the book when opened horizontally.

FIG. 7 is a view of the binding detail on an enlarged scale.

FIG. 8 is a view of the inside of the book with a printed example page when opened vertically.

### DETAILED DESCRIPTION OF THE INVENTION

Oversize page books are necessary for certain types of artwork, such as illustration based mazes, which require enough space between the lines to create maze paths. For this reason this kind of art works best in an oversize format.

However, many bookstores do not want to carry oversized books. To put oversize artwork in a standard size book, it would have to be printed on two pages, which would meet at the center, which is called the book's gutter. However it is difficult to control the alignment of the artwork bound across a book gutter.

The present invention discloses a novel way to overcome the problems of making standard size books that use oversize pages by moving the binding from the center of the book to one edge and folding the pages over at the center.

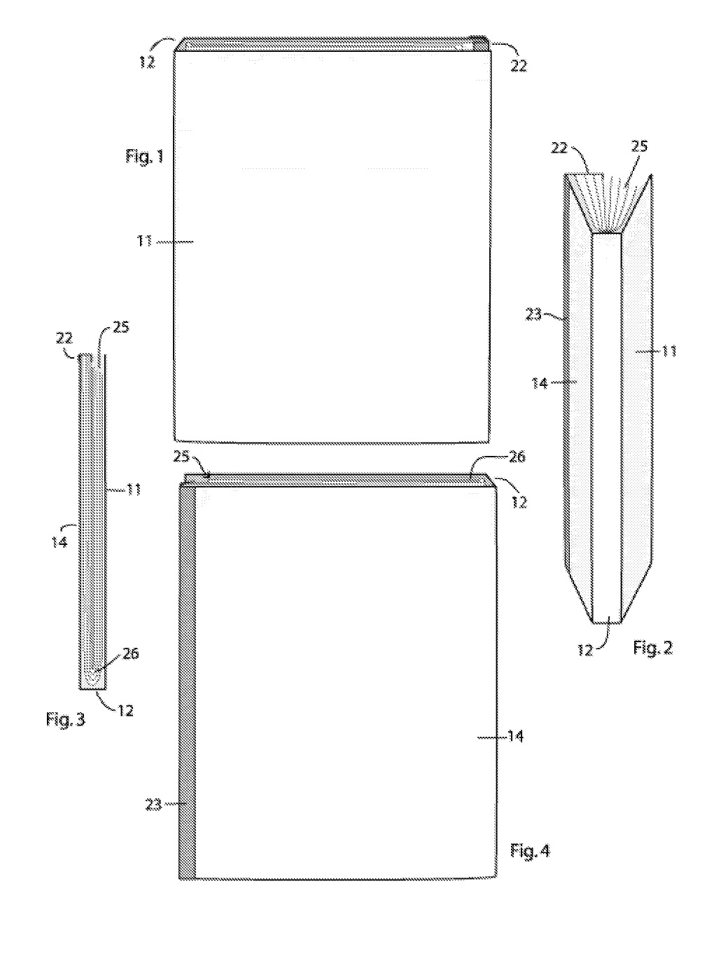

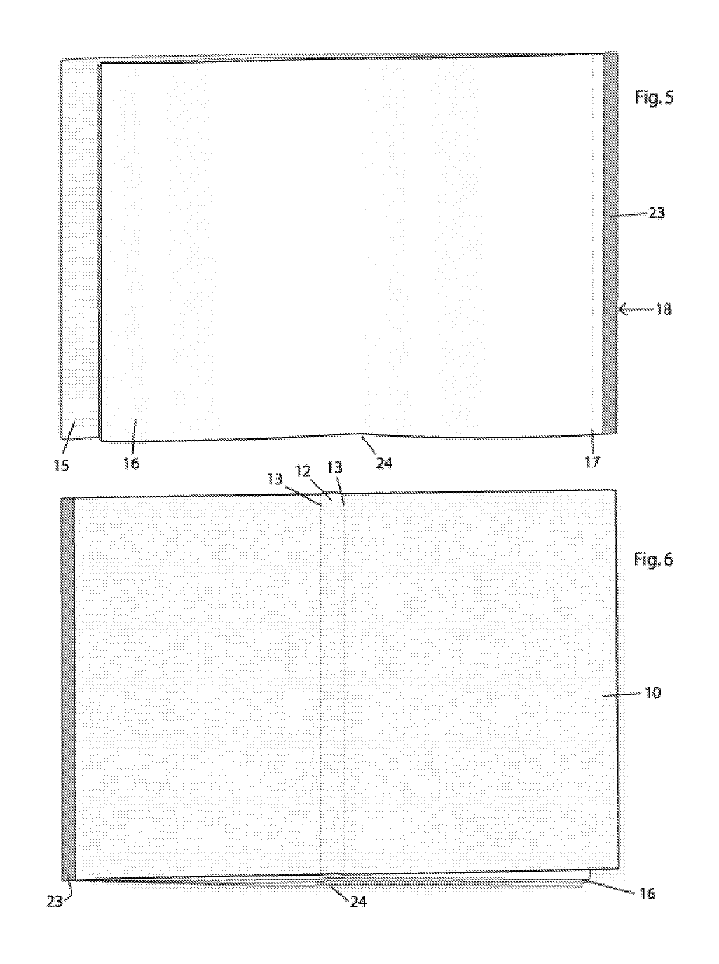

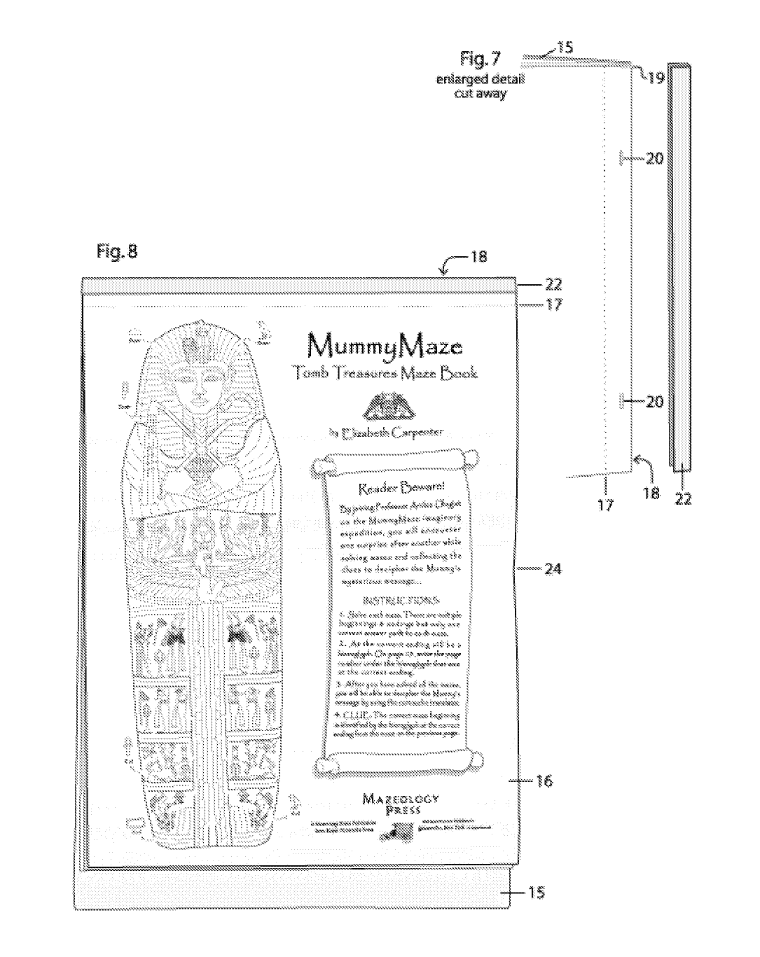

As shown in FIGS. 1-4, a cover sheet 10 is used to make the front cover, back cover and spine of the book. The cover sheet 10 is designed to be a larger size than the inside pages 16 to allow for the size of the spine 12. As shown in FIG. 3, the size of the spine 12 is calculated by measuring the dimension of the inside pages 16 when they are center folded 26. The cover 10 is then scored, using a standard and usual publishing industry scoring machine where the spine 12 will be formed along the spine score lines 13. As shown in FIG. 8, the pages 16 are printed, collated and perforated along the perforation line 17. The pages 16 are aligned face up along the rear edge 18 of the reverse side of the cover 15. As shown in FIG. 7, the aligned pages 19 are affixed to the cover by staples 20, and a binding cover tape 22 is adhered to the aligned pages 19 and the back cover 14. FIGS. 4 and 6 show part of the binding cover tape adhered to the affixing location 23. As shown in FIG. 5, the pages are folded at center 24, with the first page aligned with the perforation line 17. The remaining pages are folded on top of the first page. This creates a fan edge 25. The back cover 14 and the front cover 11 are folded along the spine score lines 13 to form the spine 12.

Note that these are not the only embodiments of the present invention. Alternatively:
The binding cover tape can be eliminated.
Other binding methods can be used as long as these methods do produce a spine and do not create a gutter.
Other binding materials can be used.
Different sizes, weights of paper and materials can be used for the cover and/or the inside pages.
Spine folds can be achieved by methods other than scoring.
Cover and/or the inside pages can be non-printed.
The inside pages are not perforated.
The inside pages can be folded along any preferred fold line.

I claim:

1. A method of making an oversize page folding book comprising:
folding a cover sheet along a pair of spine lines, to form a front cover, a back cover, and a spine of the book, where the cover sheet has a face side and a reverse side having a front edge and a rear edge;
affixing a plurality of pages to the reverse side of the cover along the rear edge of the reverse side, where the pages have a first page; and
folding the first page along a fold line and folding the remaining pages on top of the first page to form a fan edge.

2. The method of claim 1, wherein the cover sheet is scored by a scoring machine to produce a pair of spine score lines along which the spine will be formed.

3. The method of claim 1, wherein the affixing is achieved by stapling the plurality of pages to the reverse side of the cover.

4. The method of claim 1, further comprising:
adhering a binding cover tape to cover the affixing location.

5. The method of claim 1, wherein the fold line is the centerline of the pages.

6. The method of claim 1, wherein the pages are perforated along a perforation line.

7. The method of claim 6, wherein the fold line is determined by requiring the un-affixed side of the first page to align with the perforation line when folded.

8. An oversize page folding book comprising:
a cover sheet, folded along a pair of spine lines, to form a front cover, a back cover, and a spine of the book, where the cover sheet has a face side and a reverse side having a front edge and a rear edge; and
a plurality of pages, affixed to the reverse side of the cover along the rear edge of the reverse side, where the pages have a first page, with the first page being folded along a fold line and the remaining pages folded on top of the first page to form a fan edge.

9. The oversize page folding book of claim 8, wherein the cover sheet is scored by a scoring machine to produce a pair of spine score lines along which the spine will be formed.

10. The oversize page folding book of claim 8, wherein the pages are affixed by one or more staples.

11. The oversize page folding book of claim 8, further comprising:
a binding cover tape, covering the affixing location.

12. The oversize page folding book of claim 8, wherein the fold line is the centerline of the pages.

13. The oversize page folding book of claim 8, wherein the pages are perforated along a perforation line.

14. The oversize page folding book of claim 13, wherein the fold line is determined by requiring the un-affixed side of the first page to align with the perforation line when folded.
